(19) United States
(12) Patent Application Publication
(10) Pub. No.: US 2014/0310392 A1
(43) Pub. Date: Oct. 16, 2014

(54) METHOD AND APPARATUS FOR PROCESSING COMPOSITE WEB TRANSACTIONS

(71) Applicant: Lap-Wah Lawrence HO, Campbell, CA (US)

(72) Inventor: Lap-Wah Lawrence HO, Campbell, CA (US)

(21) Appl. No.: 14/247,756

(22) Filed: Apr. 8, 2014

Related U.S. Application Data
(60) Provisional application No. 61/810,659, filed on Apr. 10, 2013.

(51) Int. Cl. H04L 29/06

(52) U.S. Cl. CPC H04L 69/16
USPC 709/223

(57) ABSTRACT

Methods and algorithms, and one of their embodiments as an intelligent network proxy, capable of non-intrusively detecting, classifying, processing, analyzing, performing chronographic functions on, measuring responses and timing related data of, measuring behaviors and real-user quality-of-experience (QoE) and events of, and actively optimizing the performance and QoE of composite web transactions between a mobile device and a host at protocol-speed are described. With the algorithms and the proxy, a composite web transaction between a client device and a host (e.g., a datacenter) servicing the client device is detected and reconstructed inline and in real-time from the transaction's constituent primary sub-transaction and secondary sub-transactions, in which the primary sub-transaction is the initial, host-bound and workload-inducing web requests and responses, while the secondary sub-transactions are the client-side related processing of sub-resources accessible from additional web- and internet-addressable hosts, with the sub-resources and their processing determined by the primary sub-transaction response.

### CROSS-REFERENCE TO RELATED APPLICATIONS

This application claims the benefit of U.S. Provisional Application No. 61/810,659 filed on Apr. 10, 2013, the contents of which are herein incorporated by reference.

### FIELD OF THE INVENTION

The present invention concerns analysis and processing of transactions between client devices, datacenters, and web-addressable resources and services in the composite web, for analysis of the transactions' behaviors and performance, for quantification, extraction, measurement, and analysis of the transactions' real user experience and actual quality-of-experience (QoE), and for optimization of the transactions' performance, delivery, and QoE, at protocol speed while preserving, post said processing, interactivity and communication invariance between the client devices, the datacenters, and the web-addressable resources and services.

### BACKGROUND

Modern web is composed of increasing numbers of internet-distributed and web-addressable resources and services (e.g., rich media, images, videos, digital advertisements, scripts, digital measurements, application programming interfaces, etc.) that are remotely invoked and accessed through the internet by a single web transaction during its lifetime of execution. Therefore, the web and web transactions are now predominantly composite, and no longer simply atomic in the form of individual web messages of request and response.

The present invention aims to address this class of problems in the internet and the web, with methods and apparatus that can analyze and process real composite web transactions (henceforth “transactions”) in the composite web, quantify and measure the transactions' behaviors and performance, and quantify and reconstruct the transactions' corresponding and resulting real user experience and actual QoE including inline QoE (I-QoE), all in vivo and without approximation and artificially generated transactions and synthetic measurements. It is expected that embodiments of the present invention would be of use to both the processing and the optimization of transactions in the composite web. What related art concentrates on solving—i.e., atomic, independent, and non-composite transactions—need now to be grouped or correlated together during processing and optimization as composite transactions.

Related art in the analysis and processing of web-based transactions (or more often their simple approximation as web messages) for performance and behavioral measurements and optimization can be classified mainly as belonging to (a) inline methods and apparatus, usually through protocol- and network-based technology, capable of handling real web-based transactions generated by real users during their time online, with this art handling web-based transactions individually or web messages exclusively without being able to handle composite transactions, or (b) offline methods and apparatus, through generating artificial and synthetic (e.g., via software) composite web transactions between client devices and hosts to emulate applications and users and their interactivity with various web resources, through which the artificial or synthetic composite transactions' performance, behaviors, and timing characteristics are sampled in vitro, with no access and insights into any real and actual transactions, nor real users and their QoE, in the internet.

Related art Class (a) in inline processing is typified by internet (TCP) packet timing measurements, through which the round-trip-times (RTTs) of actual datagrams (TCP) communication between networks and clients (e.g., mobile devices) are recorded inline, and enabled by, e.g., the TCP time-stamp option (TSopt). The most visible example concerns Content Delivery Networks (CDNs, e.g., AKAMAI, LIMELIGHT), in which TCP packets' RTTs are used to select cache servers for optimized (proximity based) content delivery from CDNs to clients, typically for cacheable browser sub-resources such as image files and video clips/fragments.

Related art Class (b) in artificial performance measurements is typified by web testing software and services and their modern variants (e.g., KEYNOTE) through which artificial composite web transactions or webpage downloads are generated from various measurement points (e.g., emulating clients' browsers and their access patterns) in the internet, and destined for the web applications and services or websites under measurements. The “response times” measured for artificially generated composite web transactions are unrelated to the real and actual (users) generated web transactions, and therefore this class of techniques is described as “offline”. They provide some level of performance approximation and indications for the web applications and services and networks being measured, but provide no data on the actual web transactions as seen and generated by the actual users of web applications and services.

### SUMMARY

The problems of processing, measuring, and analyzing composite web transactions between a client device and a host (and their associated web-addressable sub-resources) at protocol speed in the internet are addressed by (a) detecting and classifying the transactions and their sub-transactions through pattern matching, (b) performing timing (round-trip-times: RTTs) and time-stamps (events driven) related measurements at line-rate on inflight sub-transactions and their associated datagrams, (c) actively injecting and deploying event listeners, event processors, software frameworks, metadata, or attributes into the inflight sub-transactions, and analyzing their client device side processing, events, and data, particularly the events, behaviors, and timing characteristics of the sub-transactions, and (d) correlating the detected, classified, processed, and analyzed sub-transactions to reconstruct, end-to-end, their associated transactions and the transactions' real user experience, actual user QoE, events, content, behaviors, and their timing characteristics. This also enables the optimization and acceleration of transactions in the composite web for maximizing application performance and user QoE, end-to-end.

The feasibility of the embodiments of the invention is established through detailed transaction- and protocol-level measurements and data analysis of production, well known, and heavily used commercial web applications/transactions in the internet (EBAY), described herein.

In certain embodiments of the present invention, methods are detailed for classifying web applications and services into web transactions and their sub-transactions, and for detecting and classifying transactions and their sub-transactions in real-time.

In an embodiment of the present invention, an apparatus (an intelligent proxy) for inline and at-speed processing/analysis of transactions and their sub-transactions is detailed, including for transactions' classification and their timing/time-stamp data extraction through passive (e.g., non-intrusive timing and time-stamps measurements) and active (e.g., non-intrusive transaction rewrites and client-side event listeners/triggers) techniques such as inline injection driven by the proxy.

In certain embodiments of the present invention, methods for real-time and inline extractions and reconstructions of transactions' and their sub-transactions' net and constituent response times by an intelligent proxy are detailed.

One embodiment of the present invention provides a method for processing transactions between a client device and a host, the method including: detecting a transaction by detecting the transaction's primary sub-transaction from a TCP (Transmission Control Protocol) connection between the client device and the host; detecting, intercepting, and processing the primary sub-transaction's response from the TCP connection; injecting and deploying at least one of event listener, event processor, software framework, metadata, attribute, or reference to one of the preceding, into the intercepted primary sub-transaction's response at protocol speed; detecting and processing secondary sub-transactions in real-time for said transaction through said at least one of event listener, event processor, software framework, metadata, attribute, or reference to one of the preceding; and reconstructing content, behavior, events, and timing characteristics of said transaction at protocol speed through the detected and processed primary sub-transaction and secondary sub-transactions of said transaction.

Another embodiment of the present invention provides an apparatus for processing transactions between a client device and a host, the apparatus including: a TCP splicing sub-system that terminates an incoming TCP (Transmission Control Protocol) connection from a client device to a host; a classifier that detects, through pattern matching, an onset of a transaction by detecting the transaction's primary sub-transaction and a request of the primary sub-transaction from the TCP connection; the TCP splicing sub-system further intercepts and temporarily stores the primary sub-transaction's response, which is extracted from the TCP connection; the classifier further processes the primary sub-transaction's response, performs high-speed pattern matching and analysis on the response, locates all sub-resources embedded within the response, and injects and deploys at least one of event listener, event processor, software framework, metadata, attribute, or reference to one of the preceding into the response for detecting and processing secondary sub-transactions corresponding to the sub-resources; a timer that measures the timing characteristics of the primary sub-transaction, and stores the timing characteristics of the primary sub-transaction in a database; an analyzer that analyzes content, behaviors, events, performance data, and their timing characteristics of the primary sub-transaction; a policy enforcer exerts policy based processing on the TCP/IP datagrams that belong to the primary sub-transaction; the analyzer further detects and processes the secondary sub-transactions' content, behaviors, events, performance data, and their timing characteristics by the at least one of event listener, event processor, software framework, metadata, or attribute; and a transaction manager that reconstructs the transaction from the detected and processed primary sub-transaction and secondary sub-transactions.

The technical advantages of certain embodiment of the present invention compared with existing methods are: web-based transactions, web applications, web services, and mobile applications in the composite web can, for the first time, be classified into precise, actionable, users-impactful, and measurable units as composite web transactions and their sub-transactions, which in turn can be detected, processed, measured, and analyzed inline at protocol speed while they are in flight, with their net response times and their components' response times, their events and timing characteristics, and their real user experience and actual QoE reconstructed in a single pass through a single (e.g., datacenter-situated) intelligent proxy, end-to-end between a (mobile) client and a host and their associated web-addressable resources. This effectively provides a solution to the composite web transactions and the composite web problem, and the associated problem of real user experience and actual QoE in the composite web.

Henceforth, regarding terminology, a “web transaction” or a “transaction” means a composite web transaction, which can have zero (empty transaction), one (atomic transaction), or more than one sub-transactions.

### BRIEF DESCRIPTION OF THE DRAWINGS

FIG. 1 shows an end-to-end network topology of intelligent proxy in a web-application hosting datacenter for servicing (mobile) clients/devices.

FIG. 2 shows the core architectural and processing modules of intelligent proxy.

FIG. 3 shows a web transaction (atomic, without sub-transactions).

FIG. 4 shows web transaction composed of three sub-transactions, one primary sub-transaction and two secondary sub-transactions (a composite web transaction).

FIG. 5 shows a modern web browser and its webpage, and the DOM (Document Object Model) and render trees of the browser engine.

FIG. 6 shows the result webpage of a product search.

FIG. 7 shows a protocol and packet diagram with timing information, detailing a web transaction.

FIG. 8 shows primary sub-transaction processing by the intelligent proxy in ingress direction (from client to proxy/datacenter).

FIG. 9 shows primary sub-transaction processing by the intelligent proxy in egress direction (from proxy/datacenter to client).

FIG. 10 shows primary sub-transaction's response time, measured and estimated as a function of round-trip-times (RTTs) and the time elapsed between the sub-transaction's request and response time-stamped in the intelligent proxy.

FIG. 11 shows the processing flow and events of proxy-controlled client side processing through content transformation of primary sub-transaction's response, through which inline/URI-defined scripts (implementing event listeners, event processors, software frameworks, metadata, or attributes) are inserted by the proxy and executed by the client.

FIG. 12 shows the timing (of events, messages, and processing) diagram and response times of proxy-controlled (script injection) client-side processing.

FIG. 13 shows the packets and protocol messages and timing details of a real-life web transaction in the internet (eBay), reconstructed through packet capture and protocol/timing analysis.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

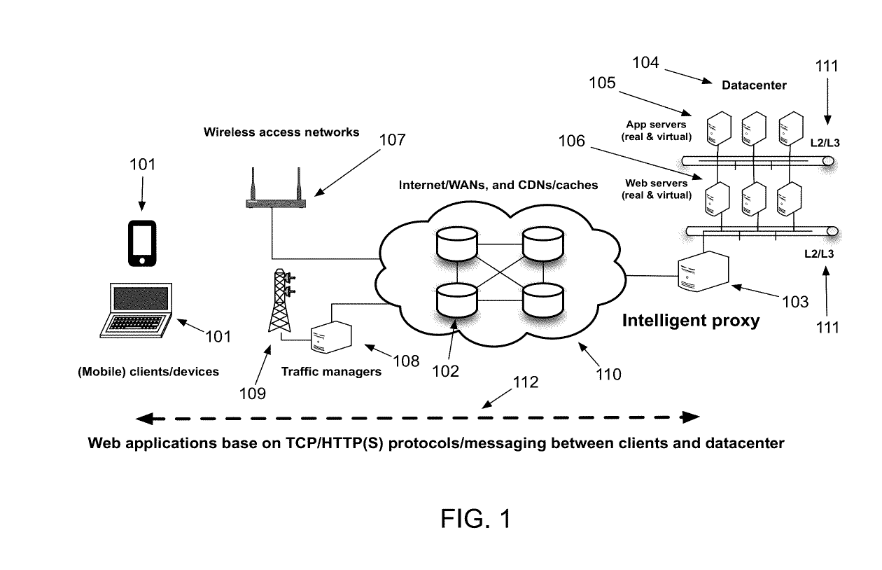

Embodiments of the invention concern the methods and their apparatus as an intelligent networking proxy 103 for web applications aware and web transactions related processing, particularly for detecting, classifying, and reconstructing web transactions, measuring and analyzing web transactions' behaviors, events, timing characteristics and responses related data (chronographic functions), and using these information to accelerate and optimize web transactions' performance end-to-end, from mobile devices 101 to a datacenter 104 that service web applications to the said mobile clients 101, and performing these functions in real-time and at protocol speed (FIG. 1).

The intelligent proxy 103 is an inline (datapath) networking device—or a networking device receiving mirrored bi-directional datapath network traffic (e.g., via visibility fabrics like GIGAMON, or Ethernet port mirroring)—that intercepts and processes all TCP flows/packets and HTTP(S) messages 112 into and out of a datacenter 104 (or it can be deployed in any other appropriate parts of an IP-addressable network 110, between a datacenter 104 and wireless access networks 107/108/109). These TCP flows and HTTP(S) messages 112 constitute communication sessions between (mobile) clients 101 (e.g., smartphones, laptops, and tablets) and the datacenter 104 for web applications/services. For example, a smartphone's web browser would communicate with various electronic commerce (e-commerce) websites (hosted by one or more datacenters 104) to obtain web-based services such as product search/queries, and (economic) transactions (e.g., goods/services purchasing), which are commonly known as web applications or web services. For web applications the datacenter 104 is responsible for scheduling the appropriate compute and storage resources 105/106 necessary to service the web applications that are requested by (mobile) clients 101. The intelligent proxy 103 located in the datacenter processes all TCP/HTTP(S) based communications 112 between the (mobile) clients 101 and the datacenter 104 on behalf of the datacenter so that these web applications can be analyzed and processed intelligently and at protocol speed, and thereby be optimized and accelerated. The end-to-end topology is summarized and illustrated in FIG. 1.

An embodiment of the intelligent proxy 103 can be an all-software suite composed of Operating System (OS) (e.g., LINUX) kernel modules and user-space processes, executing on commercial-off-the-shelf (COTS) multi-core processors or multi-processors (e.g., x86_{—}64, MIPS64, etc.), or as standalone physical datacenter appliances/switches, or as software-based virtual machines (VMs) scheduled and managed by virtualization hypervisors in the server clusters of a datacenter 104. Another embodiment of the intelligent proxy 103 can be a suite of software modules and configuration data embedded in, and interoperating with, existing and commercial-off-the-shelf (COTS) datacenter software or networking software (e.g., network appliance based), including open-source software, such as web server software running on web servers 106 (e.g., APACHE, NGINX). Embodiments with hardware acceleration for specific processing (e.g., regular expression “regex” based string search and pattern matching) using GPUs (Graphics Processing Units), co-processors, FPGAs (Field Programmable Gate Arrays), or ASICs (Application Specific Integrated Circuits) would also be feasible, depending on use-cases and economic considerations.

The intelligent proxy 103 (or proxies) is deployed at the boundary of the datacenter 104 so that all TCP/HTTP(S) traffic 112 between the datacenter and all its (mobile) clients must transverse through this inline proxy into and out of the datacenter 104 (FIG. 1). At the backend (inside the datacenter), this proxy 103 fronts datacenter servers 106 so that ingress TCP flows and egress TCP flows to and from the (e.g., web) servers 106 also transverse this proxy 103 (FIG. 1). This intelligent proxy 103 can be deployed together, and transparently, with the usual assortment of datacenter networking devices such as L2/L3 switches and routers 111, firewalls and security devices of the various sorts, and server load balancers (L4-7/ADC), etc.

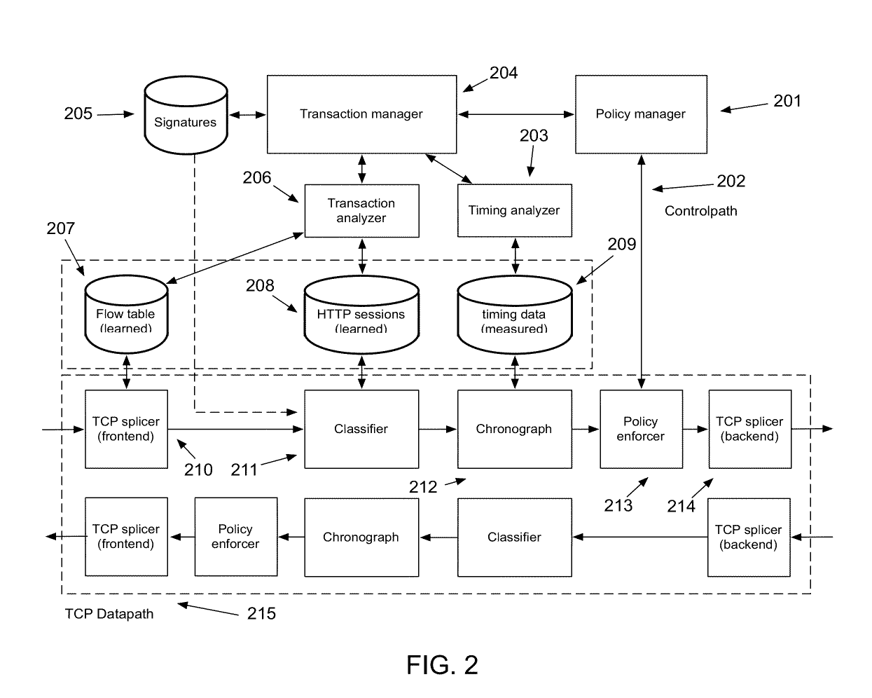

The intelligent proxy 103 is composed of the following main architectural, processing, and algorithmic blocks (FIG. 2)—
1. A high-performance (line-rate/protocol-speed, e.g., 10 gigabit/second duplex) TCP splicer (with splicer frontend 210 and splicer backend 214) that terminates all TCP connections (of TCP port 80/443: HTTP/HTTPS) between (mobile) clients and the datacenter, for the purpose of inline processing and analysis and content rewrites. On each termination of an incoming TCP connection designated for the datacenter/proxy, this TCP splicer 210/214 delay-establishes (post processing/analysis by proxy) a new TCP connection between the intelligent proxy and the destination datacenter server, and performs, at line-rate, TCP/IP protocol-level translations and rewrites (e.g., TCP segment seq/ack numbers translations and stitching, IP address(es) and port number(s) translations, checksum calculations, etc.). Effectively, a single original TCP connection (without the splicer) between a mobile client and a datacenter server (physical or virtual) is now intercepted and broken transparently, and non-intrusively, into two connected (by proxy) TCP connections that are “stitched” together by the intelligent proxy 103 and its splicer 210/214. This is done without the mobile client and the datacenter server being aware of the “splicing and stitching” from a protocol and networking standpoint (therefore non-intrusively). This applies to both egress and ingress directions (duplex) (FIG. 2).
2. A high-performance classifier 211 that searches for, at line-rate, web transactions, as defined by the transaction analyzer 206 (details below) (FIG. 2). The classifier 211 performs application-ware DPI (deep packet inspection) searches and pattern matching (e.g., regular expression “regex” string searches) into the reconstructed payloads (e.g., HTTP messages) of buffered TCP packets (TCP connection terminated previously) to detect and filter HTTP protocol metadata (e.g., message types), perform string (regex) searches/matching against HTTP messages and their contents (e.g., URIs/URLs) and other information embedded in the HTTP messages and their payloads (e.g., HTML/text data and files). The associated search signatures 205 of classifier 211 are defined through the transaction manager 204 and policy manager 201 (e.g., ultimately by a datacenter administrator or an automated and web-addressable “cloud” signatures service in the internet), and are preprocessed and stored in a signatures database 205 for the classifier 211 to use in (e.g.) regex-based string search into TCP packets and HTTP messages (FIG. 2). Additional search criteria and search patterns are defined through the transaction manager 204 and policy manager 201, such as protocol related metadata. These signatures- and context-driven application searches can be executed across multiple buffered (at the proxy 103) TCP packets and their payloads in a single TCP connection, in both directions (or more accurately, two spliced TCP connections acting as a single TCP connection). An example of such a DPI/message search would be string and regex search for a TCP connection and associated packet(s) with an incoming HTTP GET message (a signature from 205) with a predefined URL form and content (a signature in the form of a regex from 205) that indicates a HTTP request for a web-based “product and service” query in the form of a URL, initiated from a mobile client. Another example would be, in the reverse direction (from datacenter to client) the HTTP OK message of type (text/html) of the HTTP response of the previous web request example. The patterns (or signatures 205) that this classifier 211 uses for string DPI/message/protocol-metadata searches can be defined by regular expressions and protocol (e.g., TCP, HTTP) metadata, as user-input policies propagated and managed by the policy manager 201 and transaction manager 204. The purpose is for the classifier 211 to detect, at protocol-speed and line-rate, TCP flows and HTTP messages (and their contents) that constitute parts or wholes of web transactions and their sub-transactions (these two concepts are precisely defined later).
   Note: HTTPS messages are first decrypted by the intelligent proxy into HTTP messages before any HTTP-level processing (e.g., classification) is performed by the proxy. Hence, from now on HTTP means HTTP/HTTPS.
3. A line-rate chronograph 212 (stop-watch, or timing/time-stamping, module) that performs timing measurements and time-stamping operations (e.g., based on system/OS time ticks) on packets and their data/contents, protocol-related data and messages, or (predefined) events, that the proxy 103 receives or detects. These events are either generated and received locally at the proxy 103, or generated remotely from other networked devices (e.g., clients 101) and received by the proxy 103. These include (a) timing information/data on the TCP packets and packet headers levels (e.g., TSopt in TCP header option) for inline round-trip-time (RTT) measurements of raw TCP packets, e.g., between proxy 103 and clients 101, (b) time-stamping of HTTP messages-triggered events (e.g., presence of a HTTP GET/OK of predefined type based on outputs such as search matches of classifier 211), e.g., HTTP messages between proxy 103 and clients 101 and between proxy 103 and datacenter servers 106, (c) time-stamping of events generated by the (mobile) clients 101 and received by the proxy (e.g., via active browser-based event listeners/call-backs, active browser-based event triggers, etc.) that are related to web objects (resources and sub-resources) delivery and processing executed by the clients' browser engines, (d) time-stamping of events generated by datacenter servers 105 and 106 and received by the proxy (e.g., via message-based triggers, event listeners, etc.), and (e) time-stamping of events generated by networking devices between datacenter 104 and mobile clients 101 (e.g., traffic managers 108 in the mobile evolved packet core). Time-stamping at application (HTTP message and metadata) level should be associated with the corresponding time-stamping at the TCP packet/header level (e.g., TSopt) so that further analysis can be performed by the timing analyzer 203 for response-related measurements and reconstructions. TCP-level RTT measurements are performed for all appropriate TCP packets (with TSopt set and ACK bit set) by the chronograph 212 (FIG. 2) regardless.
4. A transaction analyzer 206 uses transaction patterns/signatures 205 to—together with classifier 211 (above)—discover and detect web transactions at protocol-speed and to initiate additional processing, such as chronographic functions and timing analysis (FIG. 2). The transactions patterns/signatures defined—via transaction manager 204 and policy manager 201 (and datacenter administrators or automated cloud services)—are stateful in a HTTP sense (across multiple HTTP messages), through which multiple HTTP messages (both ingress and egress directions, detected and previously processed by classifier 211) are grouped together (correlated) by the transaction analyzer 206 into “sub-transactions,” and the appropriate sets of “sub-transactions” are further grouped together (correlated) into end-to-end web transactions (the concepts of transactions and sub-transactions, and the method of detecting and classifying and processing them, are detailed later). The transaction signatures 205 (patterns) defined are simple, in terms of regular expressions (regex) and other protocol/message related data and metadata. The resulting stateful HTTP message and protocol metadata searches (primarily through classifier 211), and the subsequent transaction-related analysis (e.g., correlations) performed by transaction analyzer 206, are automatically executed inline and in real-time by the transaction analyzer 206 and classifier 211 based on the transaction patterns/signatures 205 defined. For example, only the top-level HTTP message type (GET) and its associated URL (defined as a regex) need to be defined as transaction patterns and signatures into the transaction analyzer 206, from which all other HTTP messages and the underlying TCP connection(s) would be automatically detected (classifier 211) and statefully correlated (transaction analyzer 206) into a full web transaction correlated from its detected sub-transactions. Exact algorithmic and processing details of this will be detailed later. Here transaction analyzer 206 is architecturally defined as the core transaction analysis engine with input policies (transaction patterns/signatures 205) from the policy manager 201 and transaction manager 204, that would in turn drives the automatic detection and correlation of web transactions and sub-transactions, and further drives their timing and time-stamping related analysis (through chronograph 212 and timing analyzer 203) (FIG. 2).
5. A timing analyzer 203 that reconstructs—from the various (event-driven) time-stamps (e.g., arrival of HTTP message at the proxy) and timing data (e.g., TCP-based RTTs) measured and collected by the chronograph 212, and the transactions and sub-transactions reconstructed and correlated by classifier 211 and transaction analyzer 206—the response times (times elapsed) of the various event-pairs (time elapsed between a pair of events constitutes a response time), particularly the net response times of web transactions (e.g., web transactions' start-and-stop event pairs) and the response times of their constituent sub-transactions. For example, the time elapsed between a web transaction's first HTTP GET message (from client 101 to proxy 103) event and the corresponding HTTP OK event (from datacenter server 106 to proxy 103, en route to client 101) corresponds to the response time of processing a HTTP request by the datacenter, without the network-based (RTTs) delays associated with the request and the response and the additional latencies incurred through the clients' downloading/loading/rendering of the response-specified web sub-resources (e.g., images, videos, etc.). Together with the network-based delays measured as TCP-TSopt based RTTs by the chronograph 212, and the time-stamp of the client-side event “all sub-resources downloaded and rendered on browser”), the timing analyzer 203 reconstructs the entire (net) web transaction's response time from the start of transaction (when client initiate web transaction) to the end of transaction (when results of transaction are fully rendered on client's browser). (Note: these will be explained in details later). All response times belonging to the same web transaction (from transaction analyzer 206) are used to reconstruct the total/net response time of the web transaction. Statistical properties and moments of response times and net response times can be computed and stored by the timing analyzer 203 and the timing database 209.
6. A high-performance policy enforcer 213 that performs policy-driven actions on web transactions, their content, and their TCP flows (e.g., IP address rewrites, flow load balancing, URL-rewrites, content transformations on transaction requests/responses, traffic management on TCP flows, etc.). The policy enforcer 213 uses predefined policies supplied by the policy manager 201 (including adaptive policies based on real-time analysis of data such as timing and transaction responses data) to control, optimize, and accelerate web transactions delivery and processing both inside and outside the datacenter inline and in real-time, end-to-end (FIG. 2).

For the purpose of intelligent processing, and similar to the conventions used in the internet and networking industries, web applications/services/APIs are broadly defined as involving (mobile) clients 101 submitting requests (and their attendant non-trivial compute and storage workloads) over the internet to be processed by datacenters' 104 compute and storage resources 105/106, through which the corresponding responses are generated by the datacenters and communicated back to the clients for rendering (browsers) or non-browser-based software ingestion and consumption. In this “client-server” model that are foundational to the web, three main and necessary components are present: (a) (mobile) client software in the form of web browsers or their embedded browser variants (e.g., hybrid mobile applications), and non-browser-based software and applications (e.g., ABR-Adaptive Bit Rate-video players, scripts, software, utility such as CURL), (b) client and datacenter (bi-directional) communications in a distributed client-server architecture, based on standard web protocols such as HTTP, and (c) datacenter and its compute/storage (etc.) resources (physical and virtual) being used to service and process clients' requests in real-time and generate the corresponding responses. Examples of such (non-trivial workload) web applications include browser based productivity apps, e-commerce products/services search, and economic transactions (e.g., goods purchasing, stock trading, etc.); or non-browser based applications such as RESTful web APIs for VoIP, storage, and M2M applications. In all these cases, clients, through their dynamic web requests and their HTTP messages, request services and induce non-trivial workloads in the datacenters, which in turn service the requests by scheduling compute/storage resources such as web and application (script) and database servers, and storage clusters and database clusters, etc.

For the intelligent proxy 103 to process web applications/services effectively inline and at protocol-speed, web applications are broken down into three (major) constituent steps during their operations end-to-end, as follows:
1. A Client (browser or non-browser application) initiates a “web transaction” and its associated request(s), and submits this web transaction to be serviced by one or more datacenter(s) and other network-connected device(s) (e.g., CDNs and caches). This is the start of a web transaction,
2. The said web transaction's request(s) is (are) being processed by the datacenter(s) through compute and storage resources, and its(their) response(s) generated, and the response(s) delivered to the original client. All network-based communications involving the web transaction between the client and the datacenter(s), and any other intervening network connected devices, are based on standard web protocols (e.g., HTTP/HTTPS) and their internet Protocol bearers (TCP/IP), and
3. The client's web browser loads, parses, renders and displays the responses of the said web transaction for the user to view (browser's viewport), or the client's non-browser based software ingests and consumes the responses of the said web transaction. This is the end of the web transaction.

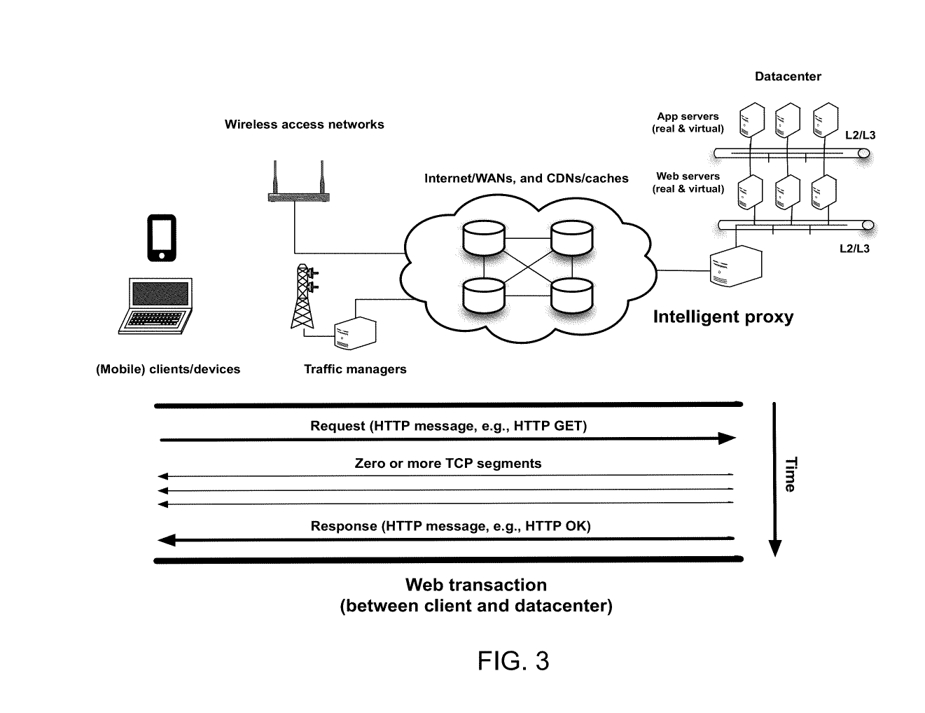

This concept of a web transaction is illustrated in FIG. 3. In FIG. 3, the web transaction illustrated is “atomic”, i.e., constituted of a single pair of HTTP request/response (i.e., no constituent “sub-transactions”). The atomic web transaction is stateless in a HTTP sense, i.e., there is no context nor state saved between successive HTTP requests. This type of web transactions is the usual term “web transactions” used in the web/internet industry, and commonly referred to and referenced in today's web applications and the internet (c. 2013).

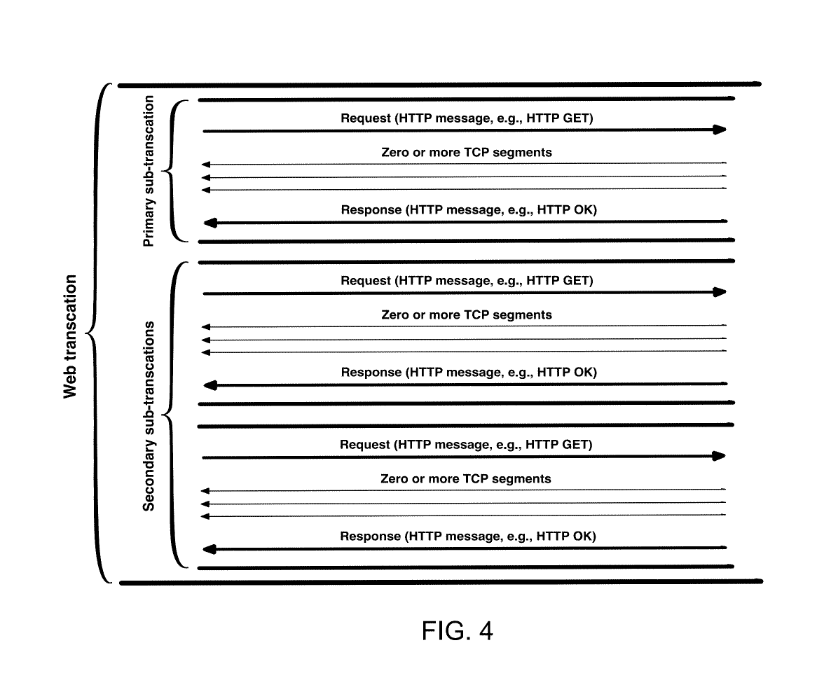

Here, we further extend the conventional concept of a web transaction into a “composite” web transaction (hereafter referred to simply as a web transaction) for the purpose of intelligent processing, in which a web transaction is constituted of “sub-transactions,” each individually is of the type illustrated in FIG. 3. FIG. 4 illustrates a web transaction made up of its sub-transactions.

These sub-transactions, the primary sub-transaction and secondary sub-transactions (FIG. 4) (which together form a “composite” web transaction), can be served and processed by different datacenters or network-based services (e.g., CDNs, caches, ad servers). For example, a primary sub-transaction could be a product search sub-transaction processed by a datacenter with the resulting response as a base web page (HTML/XHTML file or document), a standard way to invoke web applications/services in the internet. The remaining sub-transactions (secondary) are driven by this first (primary) sub-transaction's response in the form of a base HTML file and its embedded URIs that are processed by the client's browser engine, which in turn triggers additional secondary sub-transactions as individual sub-resource (e.g., .jpg file) downloads from a Content Delivery Network (CDN) and its caches. There is a one-to-one correspondence between URIs (in the response HTML file) and the sub-resources needed to complete the webpage/transaction. Together these primary and secondary sub-transactions constitute the web transaction (FIG. 4), and get loaded and rendered totally by a client's browser engine as a (dynamic) webpage.

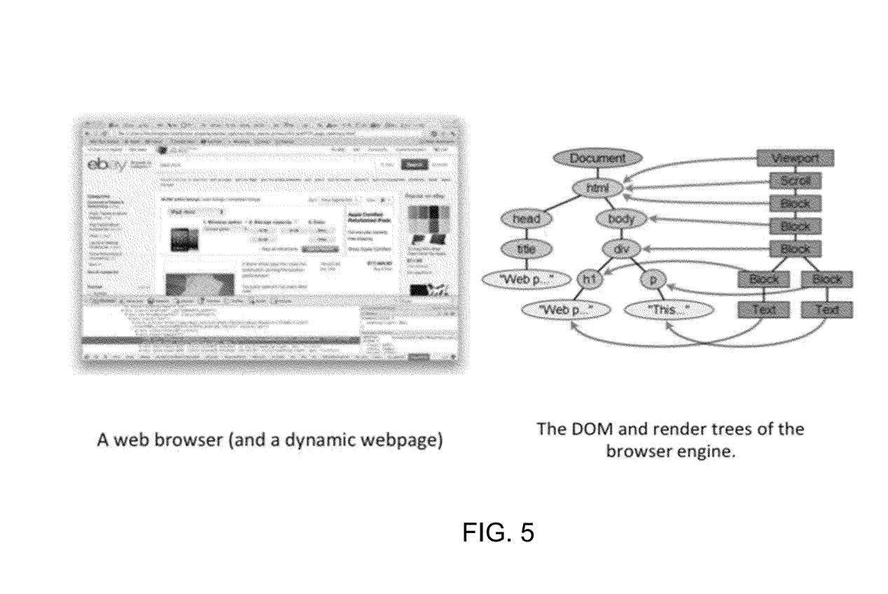

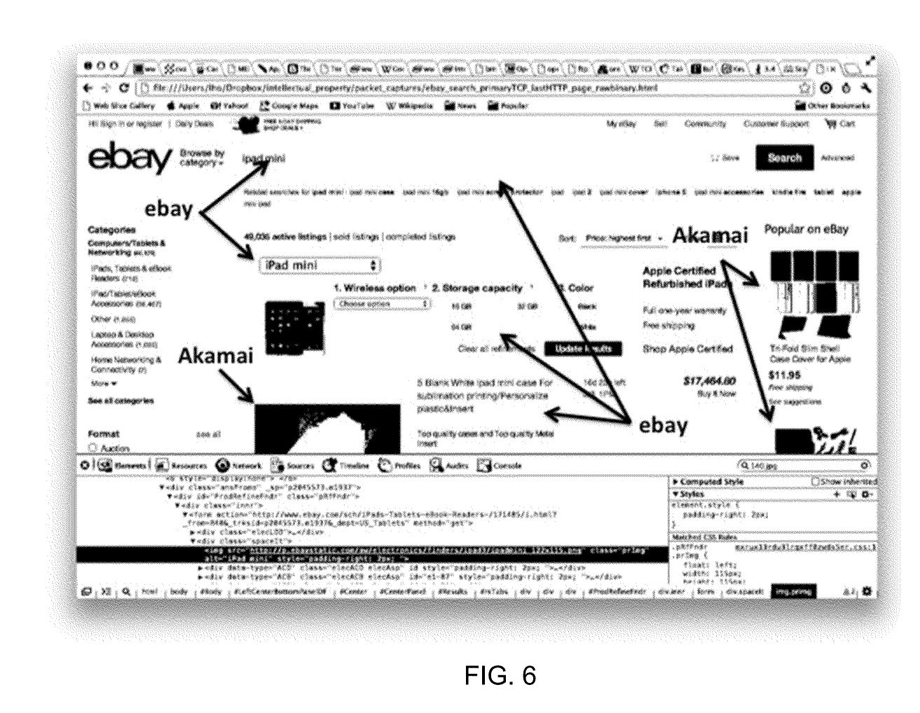

There are three important reasons why modern web applications, web services/APIs are made up of composite web transactions—
1. Web applications are predominantly (mobile) browser-based, and these applications generally involve a series of representational state transfers (commonly known in the industry as REST). Each representational state is a dynamic webpage, and as users (i.e., via browsers) use/navigate a web application, state transitions occur from webpage to webpage (or from webpage to a page update, which is a webpage). For most (datacenter) workload-induced web applications (e.g., product search, purchasing, stock trading), the transition from one web page (e.g., search page/form) to the next web page (e.g., search results) can be effectively and simply modeled as a web transaction composed of its sub-transactions—the search request (e.g., a HTTP GET message) and its response (a base HTML/XHTML file—the container object in the terminology of browsers) as a single and “first” (primary) sub-transaction, and the individual items/web objects and images defined as embedded URIs in the said HTML/XHTML file as the subsequent and remaining (secondary) sub-transactions during their downloads (these URI-referenced web objects are also called sub-resources in the terminology of browser engines).
2. A modern web browser (e.g., GOOGLE CHROME, APPLE SAFARI, or MOZILLA FIREFOX), through its browser engine (e.g., Webkit), builds two trees when parsing and rendering a webpage (FIG. 5), as defined by a (X)HTML file. These are the DOM tree and the render tree. As the base webpage (HTML/XHTML file), which is the response of the “first” (primary) sub-transaction of a web transaction, reaches the client's browser, its browser engine starts parsing the HTML file and builds a DOM tree and a render tree. During this DOM tree process, when the browser engine encounters URI-referenced sub-resources (e.g., images, video, JAVASCRIPTS, CSSs, etc.) in the HTML file, it fires off TCP connections and their associated HTTP requests to download these sub-resources from the various parts of the internet, such as the original datacenter (that processed the first primary sub-transaction), CDNs/caches, ad servers, consumer analytics services, etc. These sub-resources induced downloads are the secondary sub-transactions after the first primary sub-transaction. Finally, the browser engine would render the base HTML/XHTML page and its (downloaded) sub-resources into a full webpage for a user to view and use through the browser's viewport. At this point the entire web transaction is completed. This is illustrated in FIG. 6, which shows an Ebay search result page (a “ipad mini” search) that is composed of Ebay-fulfilled primary sub-transaction (the base HTML file) and the additional secondary sub-transactions (the image files downloaded from the Akamai CDN). In FIG. 6, the “EBay” originated arrows point to parts of the result webpage directly based on data embedded within the base HTML file (primary sub-transaction's response), while the “Akamai” originated arrows point to some of the sub-resources downloaded (mainly image files) via the secondary sub-transactions triggered by the base HTML file.
3. Modern web applications—indeed the modern web/internet—are composed of a federation of (loosely) orchestrated cloud services that together deliver dynamic contents to (mobile) browsers. Examples of these “cooperating” cloud services include: CDNs for content delivery, ad services for dynamic advertisement insertions, video services, search services (e.g., Google), web analytics (e.g., via page tagging), and of course, the datacenter (web transaction) services with which the browsers primarily interact. Until all sub-transactions of a web transaction are completed (downloaded and rendered on browsers), the representational state transfer from one webpage state to the next of a web application is not complete and not ready for viewing and use. This emerging and increasingly prevalent approach to process and deliver web applications and services, through federated and orchestrated cloud services, effectively make web applications/services web transaction driven and into composite web transactions made up of their sub-transactions, which are effectively the secondary web objects (or sub-resources, in the terminology of web browsers) downloaded from these orchestrated cloud services.

For these reasons and through detailed analyses, web transaction is a central concept of the modern web and modern web applications and services. Through processing web transactions the intelligent proxy 103 described earlier can perform inline and detailed application analytics for web applications/services end-to-end, from datacenters/cloud through the internet to (mobile) clients' browsers.

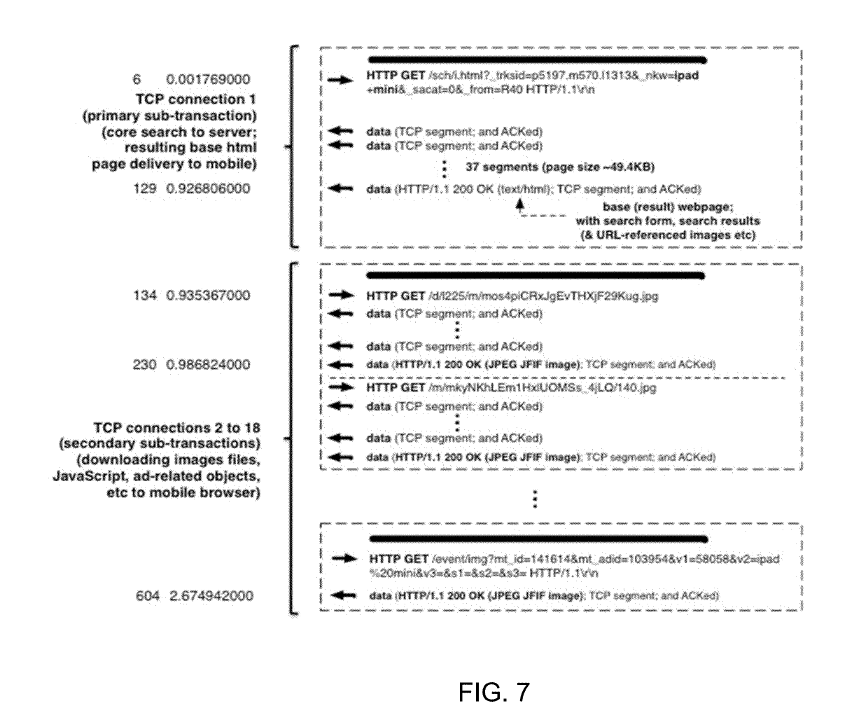

For a composite web transaction (hereafter simply as “web transaction”) composed of sub-transactions (FIG. 4), two types of sub-transactions are present—
Primary sub-transaction (FIG. 7): during a web transaction this is the first sub-transaction initiated by a client's browser, designating for a datacenter to request non-trivial compute/storage-related services rendered by the web application. Typical examples of primary sub-transaction are: HTTP GETs encoding (as URLs) requests for searches/queries (e.g., product search), products/services-related purchasing (e.g., shopping cart related transactions), stock transactions, etc. The result (response) of this primary sub-transaction is a base web page (a HTML/XHTML file or document, the container object) within which are defined additional sub-resources (in the browser engine sense, previously detailed).
Secondary sub-transactions (FIG. 7): during a web transaction these are the additional sub-transactions driven by the primary sub-transaction, particularly by its response in the form of a base page (HTML/XHTML file) and the embedded URIs within the HTML file. As these URIs are encountered by a browser engine during the HTML file parsing, additional TCP connections and sub-transactions are generated, which are designated for various parts of the internet so that the sub-resources can be downloaded from the various cloud services for the client browser to complete rendering the entire webpage. The completion of the rendering signals the end of the web transaction in question.

The details of the primary sub-transaction and secondary sub-transactions of an Ebay web transaction are illustrated in FIG. 7. (Note: These sub-transactions are reconstructed from packet-by-packet captures between Ebay/Akamai servers and our test computer, and therefore represent a real-live production environment for validating our approach and methods). In FIG. 7 can be seen the primary sub-transaction (for requesting a search of item “ipad mini”) and its response (a HTML file) and the secondary sub-transactions (mostly .jpg image files of the search results). Together, these constitute the Ebay search web transaction, which is rendered by a Chrome browser (Webkit engine) to a webpage (FIG. 6) running on our test computer. In this particular transaction, there are 1 primary sub-transaction and 17 secondary sub-transactions. The primary sub-transaction encodes the item search as an URL and its response is a HTML file (HTTP OK). This base HTML file triggers the browser engine (Webkit) to launch 17 secondary sub-transactions (and 17 TCP connections), mainly to download image files from Akamai CDNs. This web transaction is reconstructed through analysis and packet-by-packet captures between a production Ebay site and a test computer (FIG. 7).

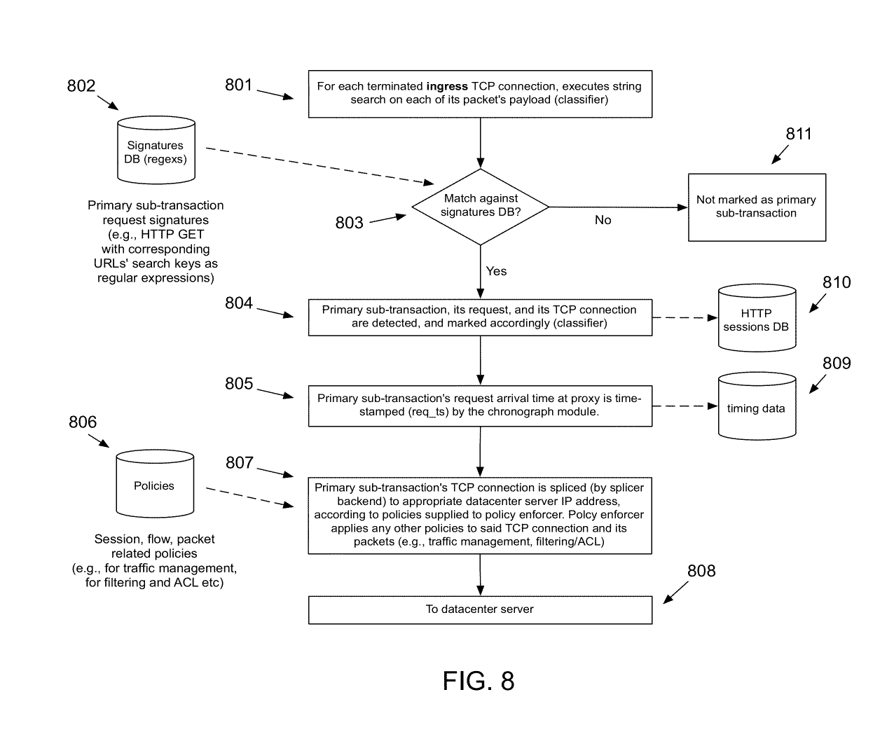

The classification of a web transaction into its constituent primary and secondary sub-transactions enables the intelligent proxy 103 (and FIG. 2) to perform high-speed and automated processing of web transactions. Effectively, to detect and to classify web transactions inflight, these operations are taken by the intelligent proxy 103 in the ingress direction (from client to intelligent proxy/datacenter), first to detect and process the primary sub-transactions (FIG. 8):
1. The intelligent proxy 103 terminates all ingress TCP connections (i.e., from client to datacenter) 801 through its TCP splicer 210 (FIG. 2), especially for those with destination TCP ports 80 and 443 (HTTP and HTTPS; for HTTPS, all communications are decrypted first, as noted previously) 801. Then the proxy's classifier 211 performs string search on all the corresponding HTTP requests and detects those requests (and the corresponding onset) of primary sub-transactions 801.
2. The search patterns (signatures 802) for detecting and classifying primary sub-transactions are predefined patterns (e.g., in the form of regular expressions, regexs) enabling string search of the URLs encoded in the HTTP GET messages of the primary sub-transactions during their initial (first time) request phase (in the Ebay “ipad mini” example illustrated in FIG. 7, this URL is: “/sch/i.html?_trksid=p5197.m570.11313&_nkw=ipad+mini&_sacat=0&_from=R40” which would trigger a string match by the regex “\/sch\/i\.hml” (for example), or a set of regexs for matching and extracting multiple fields in the above URL (e.g., matching “trksid” to extract ID, etc.). Thus a set of regular expressions (defined by an IT administrator, or an automated cloud service, through the policy manager 201 and transaction manager 204, FIG. 2) is stored in the signatures database 205 (and 802) of the intelligent proxy 103 (and FIG. 2) and is used by the proxy's classifier 211 to perform inline and (TCP) packet-by-packet string matching against an incoming TCP connection (already terminated), for all TCP connections (801). Any positive match 803 against the signatures database 802 would result in the detection and marking 804, and data/metadata extraction of a primary sub-transaction and its associated TCP connection 810 (FIG. 8).
3. The HTTP request message (HTTP GET) of this detected primary sub-transaction is time-stamped 805 by the intelligent proxy's chronograph 212 and this time-stamp is denoted as “req_ts” (meaning request timestamp) 805, which is stored in a timing database 809 for timing related analysis (FIG. 8).
4. The policy enforcer 213 of the intelligent proxy 103 applies predefined policies (e.g., for ACL, traffic management) 806 on the packets of the primary sub-transaction's TCP connection, and the TCP splicer backend 214 splices and stitches the TCP connection to a server IP address in the datacenter 807 808 (FIG. 8).

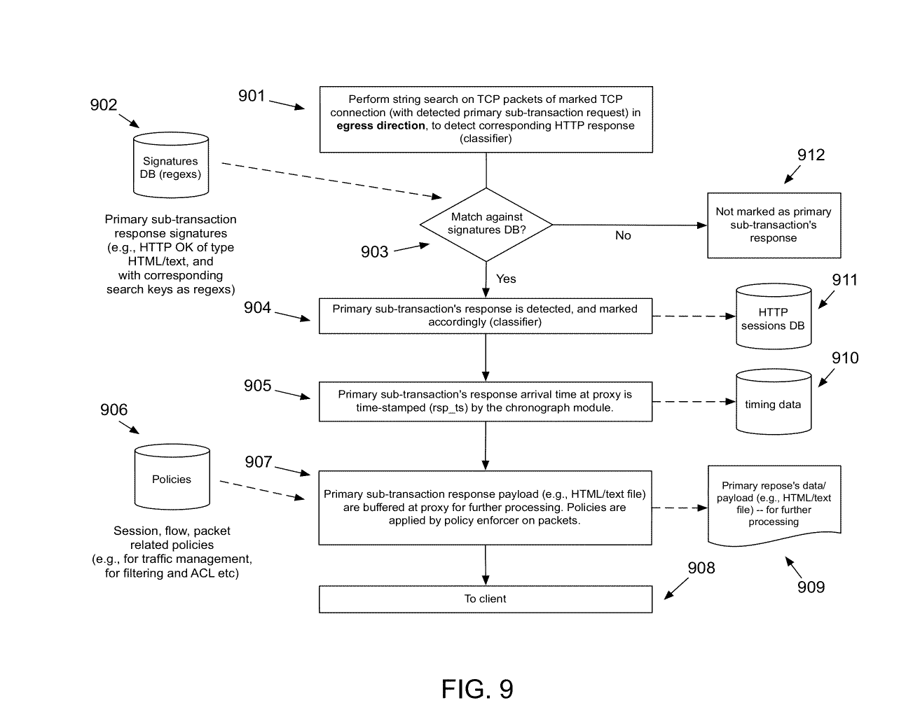

For the egress direction (datacenter to client), the intelligent proxy 103 performs similar steps and processing to detect and process the responses and traffic associated with the corresponding primary sub-transactions (after their requests' detection via the algorithms detailed before and illustrated in FIG. 8). Specifically, the following are executed (FIG. 9)—
1. For each detected primary sub-transaction's TCP connection, the classifier 211 performs string search operations (e.g., regex-based search) at the HTTP message layer to detect the response of the primary sub-transaction 901, whose transaction request has already been detected (detailed before; FIG. 8). The signatures database 902 used for the string search/matching contains regular expression (regex) defined search patterns spanning both HTTP message types (e.g., HTTP OK) and their metadata and other payload data (e.g., of type html/text) 902. As in the case of the string search for primary sub-transactions' requests, these response-related (regex) signatures are either automatically generated (upon defining the corresponding request signatures) by a cloud-based analysis and signature service, or defined by an IT administrator as part of a policy definition. As before, these response signatures are stored in the signature database 205, 902 (FIG. 2 and FIG. 9).
2. Upon successful detection 903 of a response of the primary sub-transaction (a successful string match), the classifier 211 marks the success of detecting the HTTP response message 904 and stores the related data for further analysis 911 (at the transaction analyzer 206 layer, as well as at the timing analyzer 203 layer) (FIG. 9 and FIG. 2). This detection success also triggers the chronograph 212 to time-stamp and store the arrival time of this sub-transaction response (denoted as “rsp_ts”, meaning response timestamp) 905 at the intelligent proxy. The time-stamp related data are stored in the timing database 910 for further analysis (FIG. 9).
3. Additionally, the payload of the primary sub-transaction's response, which is typically a HTML/text file or document spanning either one or more packets (usually one TCP packet), is buffered/stored temporarily at the proxy 907 for further processing, including policy-based content rewrites of the HTML/text file or other content transformations 909, before the response-related HTTP message and its corresponding packet(s) is(are) sent back to the client 908 (FIG. 9).
4. This buffered/stored response (HTML) file 909 undergoes policy-driven content rewrites and content transformations, including, but not limited to, insertions of JavaScript (either inline or through added URIs) for special and targeted client-side processing, rewrites of embedded URI for CDN related acceleration of sub-resource downloads, removals or rewrites of bandwidth consumptive sub-resources for compression related, etc. Through these policy-based rewrites and content transformations, additional transaction related processing, timing related information and data measurements and extractions, client-side detection and processing and timing related processing, and networking/content related acceleration and optimization can be carried out in real-time and inline (FIG. 9). This area will be described in details in the following sections.
5. The policy-enforcer 213, after all analysis and policy-based rewrites and transformations and actions have been completed for the buffered response of the primary sub-transaction (e.g., a HTML/text file), performs policy-based enforcements (e.g., traffic management) 907 and forwards the rebuilt TCP packet(s) (with the rewrites and transformations) to the client via the TCP splicer 908 (FIG. 9).

The primary sub-transaction's transaction response time measured at the intelligent proxy and seen at the client is (Equation 1)—

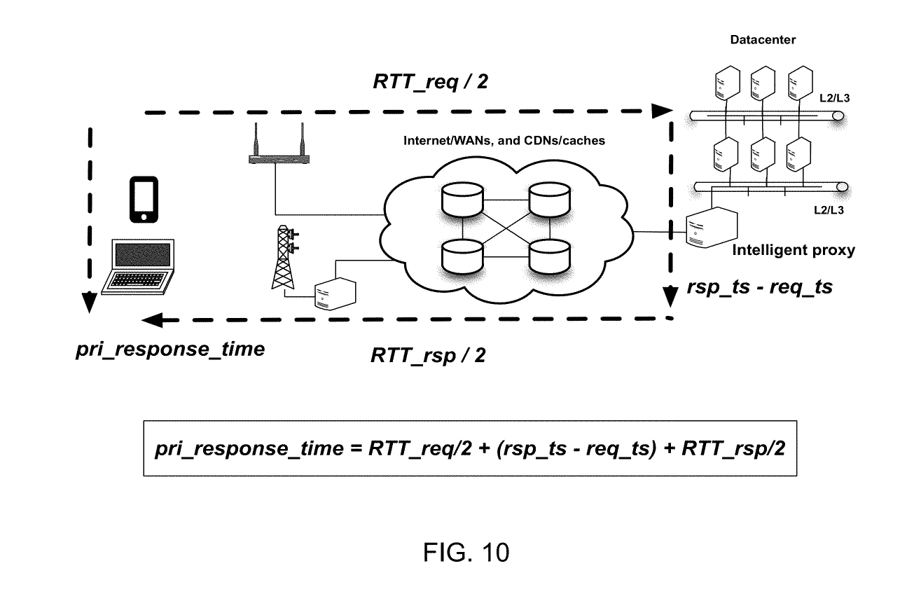

pr_reponse_time=(RTT_{—}req)/2+(rsp_{—}ts−req_{—}ts)+(RTT_{—}rsp)/2

where RTT is the round trip time measured using the TSopt (timestamp option) in TCP header (or explicitly time stamped at the TCP packet level by chronograph 212), between the intelligent proxy 103 (datacenter) and the (mobile) client 101. RTT_req is the RTT between the client 101 and the proxy 103 for the primary sub-transaction's request, while RTT_rsp is that for the primary sub-transaction's response (illustrated in FIG. 10).

The end of a primary sub-transaction is when its response (including the HTML/text file) reaches the client 101 (and FIG. 10). This HTTP response will be acknowledged in the TCP sense by the client 101 TCP/IP stack to the intelligent proxy 103 (and FIG. 10). The Intelligent proxy's TCP/IP stack and chronograph 212 records this ACK packet's time stamp, called “pri_end_ts”. The “actual” (or more accurate) time-stamp on the client when the primary sub-transaction is complete is, in fact, approximately: pri_end_ts−RTT_ack/2, where RTT_ack is measured from the TCP ACK's TSopt. This is stored in the timing database 209 of the intelligent proxy for further processing, and is called the time origin (its time-stamp on the proxy is: time_origin_ts) (Equation 2)—

time_origin_{—}ts=pri_end_{—}ts—RTT_ack/2

With the primary sub-transaction processed and its timing related and response time established and measured, the intelligent proxy 103 then proceeds to process the corresponding secondary sub-transactions of the web transaction.

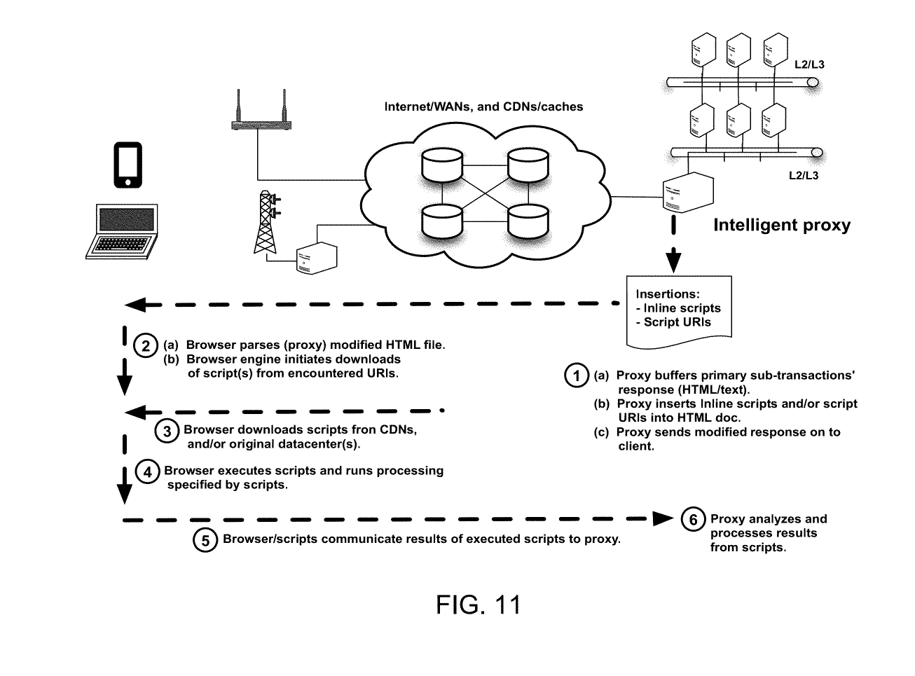

The crucial new methods and techniques that enable the intelligent proxy 103 to process secondary sub-transactions, and a whole class of non-intrusive client-side processing, concerns the techniques of rewrites and content transformations and embedding of (non-intrusive) software/script modules in the primary sub-transaction's response (e.g., the HTML/text base file), which are performed inline and in real-time on the buffered HTML/text file in the intelligent proxy detailed earlier 907 and 909 (FIG. 9). The methods and algorithms are as follows (FIG. 11)—
The primary sub-transaction's response (e.g., a HTML file spanning a single or more TCP packets) is detected and buffered (e.g., stored temporarily in the intelligent proxy 103, without being forwarded to the client 101), and the payload of the response (i.e., the HTML file) stored in the intelligent proxy's main memory for processing and content transformations (Step 1a in FIG. 11).
Important classes of content transformations include (FIG. 11):
   Insertions of client 101 (browser) side script-based events listeners and triggers and call-backs (e.g., event listeners and call-backs for webpage load complete, webpage rendering complete, client-specific information and data, user-induced events such as mouse/gesture-based events, etc., through, e.g., JavaScript) for processing events on a client using its web browser framework (e.g., browser's script engine) for the purpose of detecting client-side events (and reporting them to the intelligent proxy 103, without incurring DNS-related latencies, since the IP address of proxy 103 has already been resolved) related to timing and time-stamps related measurements, transactions-related analysis and reconstructions, and other such inline client-side events related to web transactions and their sub-transactions,
   Insertion of client-side (software/script-based) special processing and data extraction units in the form of even listeners and call-backs (e.g., detectors for high-resolution Retina displays) to detect and process client-side platform and software related data and communicate the results to the intelligent proxy 103,
   Insertion of client-side (software/script-based) special processing and data extraction units in the form of even listeners and call-backs (e.g., mouse-related user events) to detect and process client-side user events, particularly user-interface events (e.g., related to mouse, gestures), and communicate the results to the intelligent proxy 103,
   Rewrites and content transformation of primary sub-transactions' responses (e.g., in the form of HTML/XHTML files), particularly their sub-resources' URIs (e.g., for CDN load balancing and selection, image file compression), for the purpose of application/content delivery and optimization and acceleration (FIG. 11).
Note: Since the majority (estimated to be more than 97% in 2012) of modern browsers (e.g., Google Chrome, Apple Safari, Mozilla Firefox, etc.) implement JavaScript engines and interpreters (and with JavaScript processing enabled), the majority of the client-side scripts injected by the intelligent proxy 103 could be implemented in JavaScript. Obviously, other scripting languages could be used as well.
Upon completion of content transformations (e.g., script insertions via inline scripts and/or URI-based script references) of the primary sub-transaction's response (Step 1b of FIG. 11), the intelligent proxy 103 sends the modified response (e.g., updated HTML file) to the client 101 (Step 1c of FIG. 11).
Client's browser parses the proxy-modified HTML file (primary sub-transaction's response), and on encountering the inserted script URIs, downloads those scripts from (proxy)-defined locations (e.g., CDNs, original datacenters, the intelligent proxy 103, etc.) (Steps 2 and 3 of FIG. 11).
Client's browser engine (script engine) executes the downloaded scripts (Step 4 of FIG. 11), and the browser and the executing scripts communicate the results (e.g., timing data, time-stamps of events, and event triggers such as webpage loading complete, event triggers such as rendering complete, events such as successful download of certain images/files, etc.) to the intelligent proxy 103 (Step 5 of FIG. 11).
Intelligent proxy stores, analyzes, and processes the scripts' results communicated from the client (Step 6 of FIG. 11).

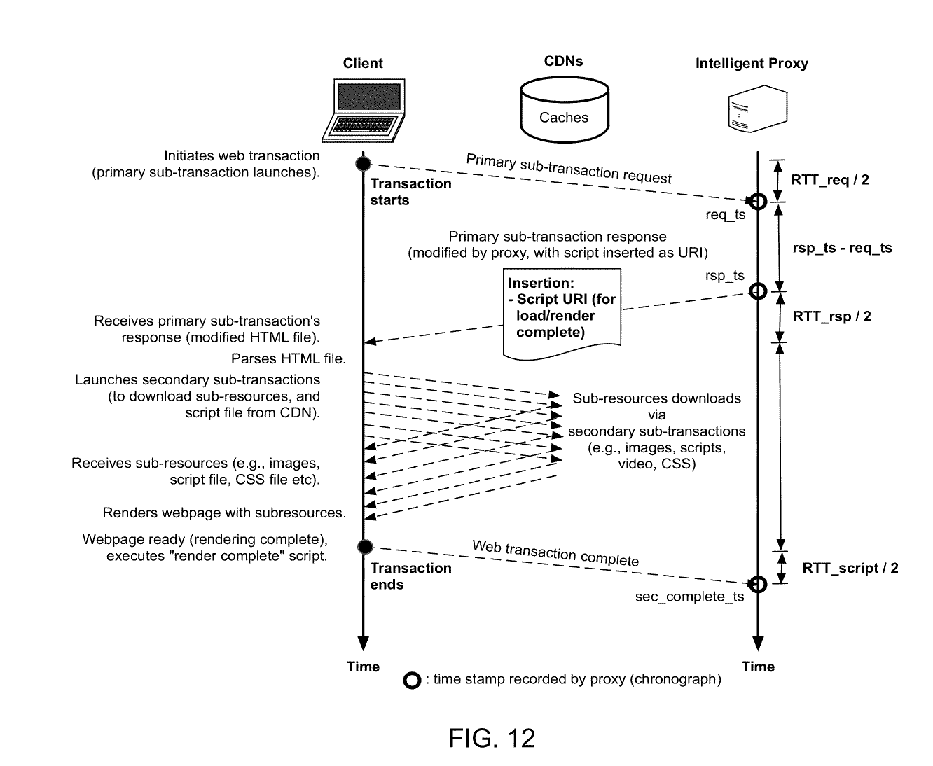

One of the useful and important applications of the proxy-injected scripts concerns processing and measuring the timing of secondary sub-transactions of a web transaction, once the intelligent proxy 103 completes handling of the corresponding primary sub-transaction. The key methods and approach here are for the intelligent proxy 103 to inject an event listener/call-back script into the primary sub-transaction's response so that the completion of the webpage loading and rendering (for example)—post sub-resources' downloads (using the secondary sub-transactions)—can be time-stamped by the script as an event, and through this “page complete” event being communicated to the proxy 103, the proxy 103 then time-stamps the completion of all secondary sub-transactions and sequential completion of associated webpage loading/rendering, which signals the end of the web transaction. Through this, overall (net) response time of a web transaction can be, for the first time, measured inline and with precision (FIG. 12).

The same method and approach summarized in the previous paragraph also applies to detecting timing and time-stamps related events of individual sub-resources (secondary sub-transactions) on the client's browser by the proxy 103. These individual sub-resources include e.g., images, videos, scripts, CSSs, inserted ads, etc. In this case, individual timing and responses of individual secondary sub-transactions (sub-resources) can be treated as individual client-side events and processed and reported to the intelligent proxy 103 for processing.

Complete and inline web transaction reconstruction is as follows (FIG. 12). By the time the intelligent proxy 103 buffers the primary sub-transaction's response, as detailed before, it already records RTT_req (through TCP's TSopt, or explicitly via chronograph 212) and two time stamps (req_ts, and rsp_ts) (FIG. 12). The proxy 103 then performs a content transformation by writing a script URI into the buffered sub-transaction response (the HTML file). This URI written could point to a CDN or the proxy or any networked storage/caching device that stores a copy of this script file being referenced. This script (e.g., JavaScript) implements an event listener/call back specifically listening to the event that the targeted web page (whose base page is the said HTML file/primary sub-transaction's response) is done loading and rendering, i.e., when the HTML file and its embedded sub-resources (e.g., images, JavaScripts, videos, CSS files, etc.) are downloaded to the client and loaded/rendered. This “page load/render complete” script obviously does not interfere with the original HTML file's content, and therefore it is a non-intrusive measurement device. Its presence as an added URI enables the client's web browser (its script engine) to execute the script upon the event that the webpage is loaded and rendered. With this added URI written, the proxy sends the hitherto buffered and now modified HTML file (response) back to the client, and during this process, also records RTT_rsp (using TCP's TSopt, and the TCP ACK sent from client to proxy upon the client's receiving the HTML file) (FIG. 12).

Once the modified HTML file is received by the client 101, its browser engine loads and parses the HTML file, and as it encounters sub-resources (typically URIs) embedded in the HTML file, it fires off TCP connections (i.e., secondary sub-transactions) to retrieve and download these referenced sub-resources from the internet (FIG. 4 and FIG. 12). The locations where these sub-resources are usually stored (controlled by the datacenter 104 or proxy 103) include CDNs and their caches (e.g., Akamai) and datacenters (including the intelligent proxy 103), or other networked and internet-connected devices including ad servers. The “page load/render complete” script is referenced by the URI previously written by the intelligent proxy 103 into the received HTML file, and is treated no differently than any other sub-resources (including other JavaScript related URIs). As the requested sub-resources are being downloaded, the browser engine renders these sub-resources in a tree-algorithm (render tree—FIG. 4). Upon completion of loading and rendering, the “page load/render complete” event listener/call-back script is executed by the browser's script engine (FIG. 12). This script opens a TCP connection from the client 101 to the intelligent proxy 103 (or reuses an existing TCP connection between them), and through this communication, the proxy's 103 TCP/IP stack or its chronograph 212 records the RTT_script (through TSopt of TCP, or explicitly) and also uses the proxy's chronograph 212 to record the arrival time-stamp of this message sent by the script, which signals the end of the web transaction (FIG. 12).

From FIG. 12, the net response time of a web transaction (with its constituent primary and secondary sub-transactions) measured at the intelligent proxy and seen at the client is (Equation 2)—

net_response_time=sec_complete_{—}ts−RTT_script/2−req_{—}ts+RTT_{—}req/2

Equation 2 provides the total (net) response time of a web transaction as seen by the client 101, without explicit time synchronization between the client 101 and the proxy 103 (e.g., via NTP or IEEE 1588), which is uncommon in web applications/services. It fundamentally depends on three things: (a) inline RTT measurements via TCP's TCPopt by the proxy 103 (or explicitly time-stamping TCP segments at the proxy via its chronograph), (b) recording of time-stamps of critical events during a transaction by the intelligent proxy 103 (its chronograph 212), and (c) the script-based event listener/call-back injected by the proxy and processed by the client (in a lightweight and non-intrusive way). With this every web transaction can be reconstructed and measured by an intelligent proxy 103.

Additionally, from FIG. 12, the total (aggregate) response time of the secondary sub-transactions is given as (Equation 3)—

sec_response_time=sec_complete_{—}ts−RTT_script/2−rsp_{—}ts−RTT_{—}rsp/2

For every web transaction, the intelligent proxy now stores three critical response-times related data in its timing database (FIG. 2)—
1. The net (total) response time of the web transaction: net_response_time (Equation 2, and FIG. 12),
2. The response time of the web transaction's primary sub-transaction: pri_response_time (Equation 1, and FIG. 10), and
3. The aggregate response time of the web transaction's secondary sub-transactions: sec_response_time (Equation 3, and FIG. 12).

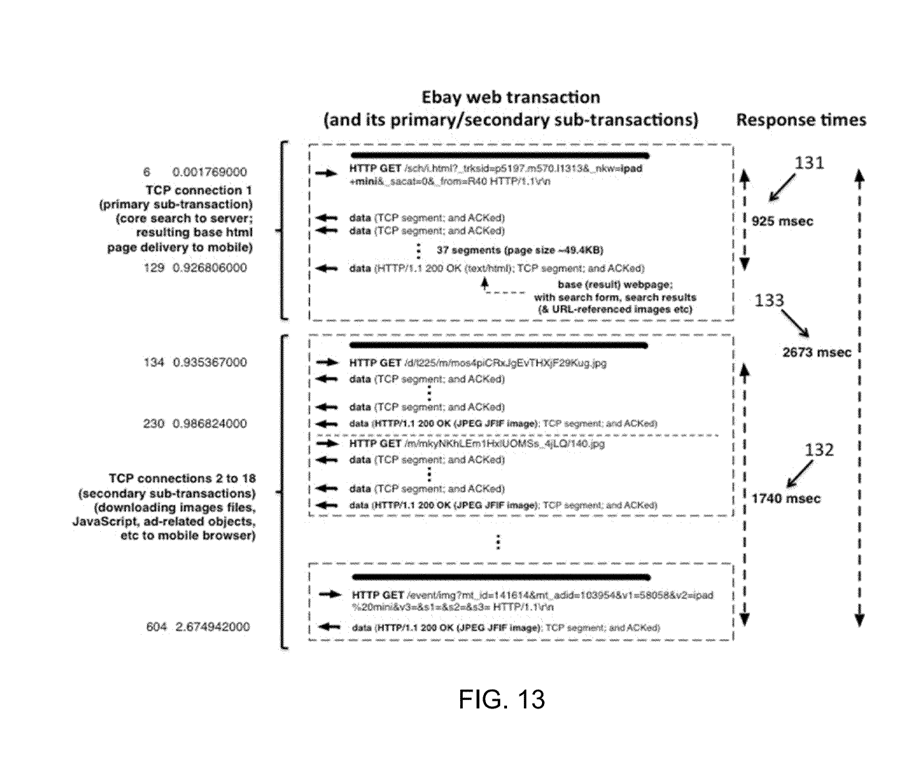

FIG. 13 illustrates the response times measured for an Ebay web transaction (FIG. 7). From packet captures and their timing analysis of the web transaction's primary and secondary sub-transactions, the following response times are reconstructed—
1. net_response_time is: 2.673 sec (133, FIG. 13),
2. pri_response_time is: 0.925 sec (131, FIG. 13), and
3. sec_response_time is: 1.740 sec (132, FIG. 13).

In this example and this particular data set, secondary sub-transactions (sub-resources that are mostly images) constitute a major portion of the net response time. The net response time of this web transaction (Ebay “ipad mini” search) is around 2.7 seconds and within bounds of the well-known quality-of-experience (QoE) of a dynamic web page (typically quoted and used in the internet community as “a few (3) seconds or so.”

These inline and real-time data enable the intelligent proxy 103 to perform analysis and analytics for web transactions and web application/services in general, as well as providing data upon which optimization and acceleration of application/transaction processing and delivery can be based, and executed through the proxy.

For example, as the proxy 103 detects that a web application/services is slowing down or decelerating (web transactions' responses are increasing), it can diagnose in real-time whether such degradations are due to decelerations in servicing primary sub-transactions (handled by datacenters' compute/storage) or due to decelerations in delivering secondary sub-transactions (mostly serviced by networks and their devices such as CDNs and caches, etc.). With this real-time and inline knowledge, remediation actions can be dispatched by the proxy 103 to counter the degradations, such as by instantiating additional compute/storage resources (VMs) in datacenters to accelerate degrading primary sub-transactions, and/or load balancing to multiple CDNs to accelerate degrading secondary sub-transactions, and/or to compress contents inside primary sub-transactions' responses, for example and so on. The overall goals are to monitor and analyze web applications/services and their web transactions in detail inline and in real-time, as these transactions are inflight, and adaptively accelerate degrading performances (in response times) by dynamically allocating additional network-based and/or datacenter-based resources to optimize and accelerate and diagnosis web applications/services in real-time end to end, from datacenters' VMs to clients' browsers, as their users are perceiving and using their web applications and services.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for processing transactions between a client device and a host, the method comprising:
detecting a transaction by detecting the transaction's primary sub-transaction from a TCP (Transmission Control Protocol) connection between the client device and the host;
detecting, intercepting, and processing the primary sub-transaction's response from the TCP connection;
injecting and deploying at least one of event listener, event processor, software framework, metadata, attribute, or reference to one of the preceding, into the intercepted primary sub-transaction's response at protocol speed;
detecting and processing secondary sub-transactions in real-time for said transaction through said at least one of event listener, event processor, software framework, metadata, attribute, or reference to one of the preceding; and
reconstructing content, behavior, events, and timing characteristics of said transaction at protocol speed through the detected and processed primary sub-transaction and secondary sub-transactions of said transaction.

2. The method of claim 1, wherein said client device is a mobile device, a nomadic device, a stationary device, an embedded device, or an internet or web enabled device; and wherein said transaction is a web transaction, a web application, a hybrid mobile application, an embedded browser engine, a web service, a web API (Application Programming Interface), or an internet or web enabled service; wherein said transaction comprises a primary sub-transaction and zero or more secondary sub-transactions; and wherein said host is a datacenter, a server, a computing device, a compute-and-storage device, or at least one internet or web enabled device; wherein, the TCP connection is a single end-to-end TCP connection directly connecting the client device and the host, a series of at least two spliced TCP connections whose one end connects the client device and whose other end connects the host for emulating an end-to-end TCP connection between the client device and the host, or a series of at least two concurrent TCP connections of the preceding single end-to-end TCP connection or series of at least two spliced TCP connections.

3. The method of claim 1, wherein the primary sub-transaction includes a workload-inducing request initiated by the client device's browser, embedded browser engine, hybrid mobile application, dynamically downloaded and embedded software within said browser, embedded browser engine or hybrid mobile application, or internet or web enabled application; and the corresponding primary sub-transaction's response being a HTML file or document, data, data stream, or data-centric updates, generated as the response by the host upon its completion of processing the primary sub-transaction's request from the client device.

4. The method of claim 1, wherein the secondary sub-transaction includes a workload-inducing request defined and triggered by the primary sub-transaction's response upon the clients device receiving and processing the primary sub-transaction's response, in that the secondary sub-transaction is triggered by a sub-resource in said primary sub-transaction's response, and the secondary sub-transaction's request initiated by the client device's browser, embedded browser engine, hybrid mobile application, dynamically downloaded and embedded software within said browser, embedded browser engine or hybrid mobile application, or internet or web enabled application; and wherein, the secondary sub-transaction's response, upon being received and processed by the client device, further triggers zero or more transactions, with their own primary sub-transactions and secondary sub-transactions.

5. The method of claim 4, wherein the sub-resource is a web object, content or media data or data, an executable object or software or code, a container of a sub-resource, an internet-addressable or web-addressable reference to a sub-resource, a set of parallel sub-resources, or a sequence of sub-resources in time.

6. The method of claim 1, wherein the secondary sub-transactions are processed by zero or more distinct hosts that are different from the host that processes the primary sub-transaction, through zero or more TCP connections that are different from the TCP connection associated with the primary sub-transaction.

7. The method of claim 1, wherein the detecting of the primary sub-transaction is based on pattern matching the primary sub-transaction's request patterns and response patterns against TCP/IP protocol information and web protocol, message and content related information embedded in the TCP connection's datagrams' headers and payloads; and wherein, successfully matching the request patterns against a TCP connection's datagrams signals the detection of the primary sub-transaction's request and the corresponding TCP connection, whose datagrams are further pattern matched against the response patterns for detecting the primary sub-transaction's response.

8. The method of claim 1, wherein the intercepting the detected primary sub-transaction's response comprises temporarily storing and buffering the response for pattern-matching, content-related analysis, software processing, or content or software injection, before the response is being forwarded to the client device.

9. The method of claim 1, wherein the injection of at least one of event listener, event processor, software framework, metadata, attribute, or reference to one of the preceding is dependent on type of the primary sub-transaction's response or its content, or types or locations or contexts of the sub-resources embedded in the response; and wherein the injection is deployed such that there is at least one injection location inside the response, with location dependent on the type of the response and its content, and the types and the locations and the contexts of the sub-resources embedded in the response.

10. The method of claim 1, wherein the injection is carried out through high-speed pattern matching a set of patterns against the primary sub-transaction's response or its content, with post-matching insertions executed on the response, effectively modifying the response's content, in which the patterns are a set of response types or response signatures, or sub-resource types or contexts or sub-resource signatures, such that successfully matching a pattern against the response and its content triggers the insertion and the locations-based deployment of a corresponding set of at least one of event listener, event processor, software framework, metadata, attribute, or reference to one of the preceding into the primary sub-transaction's response.

11. The method of claim 1, wherein the injection and deployment induces zero, or materially undetectable, difference between ways the client device processes the transaction, and the ways the client device would process an otherwise identical transaction that were without the injection and deployment; and wherein, original web object, content, media, data, software execution, visual layout, layout, and interactivity provided by, and driven by, the transaction are not affected by the injection and deployment, thereby preserving interactivity and communication invariance between the client device and the host.

12. The method of claim 1, wherein the injected and deployed primary sub-transaction's response is segmented into datagrams and forwarded in the TCP connection to the client device, which, upon receiving the response, starts processing the response and executing the injected and deployed at least one of event listener, event processor, software framework, metadata, attribute, or reference to one of the preceding, so that they are attached to, and executing in, the client device's browser, embedded browser engine, hybrid mobile application, or internet or web enabled application.

13. The method of claim 1, wherein round-trip-times (RTTs), for the primary sub-transaction's request's RTT (RTT_req) and the response's RTT (RTT_rsp), between the client device and the host are measured continuously inline, through the TCP connection's datagram-level information or by explicit time-stamps.

14. The method as defined in claim 13, wherein the detected primary sub-transaction's request is time-stamped and stored (ts_req); wherein, the detected primary sub-transaction's response is time-stamped and stored (ts_rsp); and wherein, the delay or processing time incurred by the host to process the primary sub-transaction's request and generate its response is: ts_rsp−ts_req, and wherein the primary sub-transaction's response time is: RTT_req/2+(ts_rsp−ts_req)+RTT_rsp/2.

15. The method of claim 1, wherein the secondary sub-transactions are detected by the client device's attached and executing at least one of event listener, event processor, software framework, metadata, attributes, or reference to one of the preceding, which persistently record, measure, time-stamp, or analyze the requests, responses, performance data, or their associated timing characteristics of the secondary sub-transactions of the transaction.

16. The method of claim 1, wherein the at least one of event listener, event processor, software framework, metadata, attribute, or reference to one of the preceding are inserted together with, and deployed with, the sub-resource in the primary sub-transaction's response, so that the onset of the transaction, the onset of the sub-resource initiated secondary sub-transaction, or the completion of receive, loading, or rendering of the sub-resource by the client device are detected and time-stamped, from which the secondary sub-transaction's transaction response times from the onset of the transaction (response_time_{—}2nd_nav) or from the onset of the client device initiated sub-transaction (response_time_{—}2nd_dom) are measured.

17. The method of claim 16, wherein a time difference between the response_time_{—}2nd_dom and the response_time_{—}2nd_nav of the secondary sub-transaction provides an accurate measure of speed or delay of the client device's browser, embedded browser engine, hybrid mobile application, or internet or web enabled application in processing and parsing the sub-resource in the primary sub-transaction's response, thereby providing a snapshot in time of the performance of the client device, from which statistical moments and statistical signatures of the client device's performance are constructed over time and over the sub-resources.

18. The method of claim 16, wherein the secondary sub-transactions of the transaction are ordered in descending order of their response_time_{—}2nd_nav so that the completion order of the sub-transactions, or the slowest secondary sub-transaction, are determined; and wherein, when the slowest secondary sub-transaction completes at the client device, its response_time_{—}2nd_nav signifies the completion of the loading of the transaction, measured from the onset of the transaction.

19. The method of claim 1, wherein the secondary sub-transactions of the transaction are ordered in descending order of their response_time_{—}2nd_dom, such that the longer the response time the longer it takes the client device to download the corresponding sub-resource from the web, independent of the onset of the corresponding secondary sub-transaction; and wherein, the contributions from network based delay, client-based delay, or host-based delay, to the response time response_time_{—}2nd_dom is statistically deciphered.

20. The method of claim 1, wherein the at least one of event listener, event processor, software framework, metadata, attribute, or reference to one of the preceding are used to detect the completion of the transaction through detecting an event signifying page load completion, such that all the secondary sub-transactions are completed, and the transaction's resources and sub-resources fully loaded or loaded-and-rendered on the client device; and wherein, time elapsed between the page load completion and the onset of the transaction is page load time.

21. The method of claim 1, wherein the timing characteristics of the transaction are measured and reconstructed in the form of the primary sub-transaction's response time, a list of the response times of the secondary sub-transactions, a list of timing of the events associated with the primary and the secondary sub-transactions, or the transaction's page load time.

22. The method of claim 1, wherein the largest response_time_{—}2nd_nav is smaller than the page load time, and associated with the slowest sub-resource of the page load time; and wherein, there is statistically a group of the ordered sub-transactions or their delay contributions that are slow and slowing down the page load time.

23. The method of claim 1, wherein the secondary sub-transactions are processed by the client device's attached at least one of event listener, event processor, software framework, metadata, attribute, or reference to one of the preceding, which persistently record, measure, time-stamp, or analyze the sub-transactions' content, behaviors, events, performance data, or their associated timing characteristics during the lifetimes of the secondary sub-transactions of the client device; and wherein, the response_time_{—}2nd_nav of the secondary sub-transactions are shorter than the page load time; and wherein, the reconstructed transaction has no dynamic updates.

24. The method of claim 1, wherein the secondary sub-transactions are processed by the client device's attached at least one of event listener, event processor, software framework, metadata, attribute, or reference to one of the preceding, which persistently record, measure, time-stamp, or analyze the sub-transactions' content, behaviors, events, performance data, or their associated timing characteristics during the lifetimes of the secondary sub-transactions of the client device; and wherein, at least one of the response_time_{—}2nd_nav of the secondary sub-transactions are longer than the page load time and sub-transactions continuing beyond the page load completion; and wherein, the reconstructed transaction has dynamic updates, and the updates constitute additional transactions.

25. The method of claim 1, wherein the client device's attached and executing at least one of event listener, event processor, software framework, metadata, attribute, or reference to one of the preceding persistently record, measure, time-stamp, or analyze the behaviors, events, performance data, or their associated timing characteristics of the client device, or of the client device's network connections and connectivity with access networks.

26. The method of claim 1, further comprising optimizing performance of inflight transactions between the client device and the host through actions based on the inflight transactions' data and historical trends of the reconstructed transactions and their detected and processed primary and secondary sub-transactions.

27. An apparatus for processing transactions between a client device and a host, the apparatus comprising:
a TCP splicing sub-system that terminates an incoming TCP (Transmission Control Protocol) connection from a client device to a host;
a classifier that detects, through pattern matching, an onset of a transaction by detecting the transaction's primary sub-transaction and a request of the primary sub-transaction from the TCP connection;
the TCP splicing sub-system further intercepts and temporarily stores the primary sub-transaction's response, which is extracted from the TCP connection;
the classifier further processes the primary sub-transaction's response, performs high-speed pattern matching and analysis on the response, locates all sub-resources embedded within the response, and injects and deploys at least one of event listener, event processor, software framework, metadata, attribute, or reference to one of the preceding into the response for detecting and processing secondary sub-transactions corresponding to the sub-resources;
a timer that measures the timing characteristics of the primary sub-transaction, and stores the timing characteristics of the primary sub-transaction in a database;
an analyzer that analyzes content, behaviors, events, performance data, and their timing characteristics of the primary sub-transaction;
a policy enforcer exerts policy based processing on the TCP/IP datagrams that belong to the primary sub-transaction;
the analyzer further detects and processes the secondary sub-transactions' content, behaviors, events, performance data, and their timing characteristics by the at least one of event listener, event processor, software framework, metadata, or attribute; and
a transaction manager that reconstructs the transaction from the detected and processed primary sub-transaction and secondary sub-transactions.

28. The apparatus of claim 27, wherein said client device is a mobile device, a nomadic device, a stationary device, an embedded device, or an internet and web enabled device; and wherein said transaction is a web transaction, a web application, a hybrid mobile application, an embedded browser engine, a web service, a web API (Application Programming Interface), or an internet or web enabled service; and wherein said transaction comprises a primary sub-transaction and zero or more secondary sub-transactions; and wherein said host is a datacenter, a server, a computing device, a compute-and-storage device, or at least one internet and web enabled device; wherein, the TCP connection is a single end-to-end TCP connection directly connecting the client device and the host, a series of at least two spliced TCP connections whose one end connects the client device and whose other end connects the host for emulating an end-to-end TCP connection between the client device and the host, or a series of at least two concurrent TCP connections of the preceding single end-to-end TCP connection or series of at least two spliced TCP connections.

29. The apparatus of claim 27, wherein the primary sub-transaction includes a workload-inducing request initiated by the client device's browser, embedded browser engine, hybrid mobile application, dynamically downloaded and embedded software within said browser, embedded browser engine or hybrid mobile application, or internet or web enabled application; and the corresponding primary sub-transaction's response being a HTML file or document, data, data stream, or data-centric updates, generated as the response by the host upon its completion of processing the primary sub-transaction's request from the client device.

30. The apparatus of claim 27, wherein the secondary sub-transaction includes a workload-inducing request defined and triggered by the primary sub-transaction's response upon the clients device receiving and processing the primary sub-transaction's response, in that the secondary sub-transaction is triggered by a sub-resource in said primary sub-transaction's response, and initiated by the client device's browser, embedded browser engine, hybrid mobile application, dynamically downloaded and embedded software within said browser, embedded browser engine or hybrid mobile application, or internet or web enabled application; and wherein, the secondary sub-transaction's response further triggers zero or more transactions, with their own primary sub-transactions and secondary sub-transactions.

31. The apparatus of claim 30, wherein the sub-resource is a web object, content or media data or data, an executable object or software or code, a container of a sub-resource, a web-addressable reference to a sub-resource, a set of parallel sub-resources, or a sequence of sub-resources in time.

32. The apparatus of claim 27, wherein the secondary sub-transactions are processed by zero or more distinct hosts that are different from the host that processes the primary sub-transaction, through zero or more TCP connections that are different from the TCP connection associated with the primary sub-transaction.

33. The apparatus of claim 27, wherein the classifier detects the primary sub-transaction by pattern matching the primary sub-transaction's request patterns and response patterns against TCP/IP protocol information and web protocol, message and content related information embedded in the TCP connection's datagrams' headers and payloads; wherein, successfully matching the request patterns against a TCP connection's datagrams by the classifier signals the detection of the primary sub-transaction's request and the corresponding TCP connection, whose datagrams are further pattern matched by the classifier against the response patterns for detecting the primary sub-transaction's response.

34. The apparatus of claim 27, wherein the TCP splicing sub-system temporarily stores and buffers the detected primary sub-transaction's response from the spliced TCP connection between the host and the client device, with the classifier executing pattern-matching, content-related analysis, software processing, or content or software injection, before the primary sub-transaction's response is being forwarded to the client device.

35. The apparatus of claim 27, wherein the classifier injects at least one of event listener, event processor, software framework, metadata, attribute, or reference to one of the preceding is dependent on type of the primary sub-transaction's response or its content, or types or locations or contexts of the sub-resources embedded in the response; and wherein the injection is deployed such that there is at least one injection location inside the response, with location dependent on the type of the response and its content, and the types and the locations and the contexts of the sub-resources embedded in the response.

36. The apparatus of claim 27, wherein the injection is carried out by the classifier through high-speed pattern matching a set of patterns against the primary sub-transaction's response and its content, with post-matching insertions executed on the response, effectively modifying the response's content, in which the patterns, which are stored in the signatures database, are a set of response types or response signatures, or sub-resource types or contexts or sub-resource signatures, such that successfully matching a pattern against the response and its content triggers the insertion and the locations-based deployment of a corresponding set of at least one of event listener, event processor, software framework, metadata, attribute, or reference to one of the preceding into the primary sub-transaction's response.

37. The apparatus of claim 27, wherein the injection and deployment induces zero, or materially undetectable, difference between ways the client device processes the transaction, and the ways the client device would process an otherwise identical transaction that were without the injection and deployment; and wherein, original web object, content, media, data, software execution, visual layout, layout, and interactivity provided by, and driven by, the transaction are not affected by the injection and deployment, thereby preserving interactivity and communication invariance between the client device and the host.

38. The apparatus of claim 27, wherein the injected and deployed primary sub-transaction's response is segmented into datagrams and forwarded in the TCP connection to the client device, which, upon receiving the response, starts processing the response and executing the injected and deployed at least one of event listener, event processor, software framework, metadata, attribute, or reference to one of the preceding, so that they are attached to, and executing in, the client device's browser, embedded browser engine, hybrid mobile application, or internet or web enabled application.

39. The apparatus of claim 27, wherein the timer measures round-trip-times (RTTs), for the primary sub-transaction's request's RTT (RTT_req) and the response's RTT (RTT_rsp), between the client device and the host continuously, and statistically updated, through the TCP connection's datagram-level information or by explicit time-stamps.

40. The apparatus of claim 39, wherein the detected primary sub-transaction's request is time-stamped by the timer and stored (ts_req) in a timing data database; wherein, the detected primary sub-transaction's response is time-stamped by the timer and stored (ts_rsp) in the timing data database; and wherein, the host's delay or processing time incurred by the host to process the primary sub-transaction' request and generate its response is: ts_rsp−ts_req; wherein the primary sub-transaction's response time is: RTT_req/2+(ts_rsp−ts_req)+RTT_rsp/2.

41. The apparatus of claim 27, wherein the secondary sub-transactions are detected by the client device's attached and executing at least one of event listener, event processor, software framework, metadata, attributes, or reference to one of the preceding, which persistently record, measure, time-stamp, or analyze the requests, responses, performance data, or their associated timing characteristics of the secondary sub-transactions of the transaction.

42. The apparatus of claim 27, wherein the at least one of event listener, event processor, software framework, metadata, attributes, or reference to one of the preceding are inserted together with, and deployed with, the sub-resource and its reference in the primary sub-transaction's response, so that the onset of the transaction, the onset of the sub-resource initiated secondary sub-transaction, or the completion of receive, loading, or rendering of the sub-resource by the client device are detected and time-stamped, from which the secondary sub-transaction's transaction response times from the onset of the transaction (response_time_{—}2nd_nav) or the onset of the client device initiated sub-transaction (response_time_{—}2nd_dom) are measured.

43. The apparatus of claim 42, wherein a time difference between the response_time_{—}2nd_dom and the response_time_{—}2nd_nav of the secondary sub-transaction provides an accurate measure of speed or delay of the client device's browser, embedded browser engine, hybrid mobile application, or internet or web enabled application in processing and parsing the sub-resource in the primary sub-transaction's response, thereby providing a snapshot in time of the performance of the client device, from which statistical moments and statistical signatures of the client device's performance are constructed over time and over the sub-resources.

44. The apparatus of claim 42, wherein the analyzer orders the secondary sub-transactions of the transaction in descending order of the response_time_{—}2nd_nav so that the completion order of the sub-transactions, or the slowest secondary sub-transaction, is determined; and wherein, when the slowest secondary sub-transaction completes at the client device, its response_time_{—}2nd_nav signifies the completion of the loading of the transaction, measured from the onset of the transaction.

45. The apparatus of claim 42, wherein the analyzer orders the secondary sub-transactions of the transaction in descending order of the response_time_{—}2nd_dom, such that the longer the response time the longer it takes the client device to download the corresponding sub-resource from the web, independent of the onset of the corresponding secondary sub-transaction; and wherein, the contributions from network-based delay, client-based delay, or host-based delay, to the response time is statistically deciphered.

46. The apparatus of claim 27, wherein the at least one of event listener, event processor, software framework, metadata, attribute, or reference to one of the preceding are used to detect the completion of the transaction through detecting an event signifying page load completion, such that all the secondary sub-transactions are complete, and the transaction's resources and sub-resources fully loaded or loaded-and-rendered on the client device; and wherein, the time elapsed between the page load completion and the onset of the transaction is page load time.

47. The apparatus of claim 27, wherein the timing characteristics of the transaction are measured and reconstructed by a transaction analyzer in the form of the primary sub-transaction's response time, a list of the response times of the secondary sub-transactions, a list of timing of events associated with the primary and secondary sub-transactions, and the transaction's page load time.

48. The apparatus of claim 45, wherein the largest response_time_{—}2nd_nav is smaller than the page load time, and associated with the slowest sub-resource of the page load time; and wherein, there is statistically a group of the ordered sub-transactions that is slow and slowing down the page load time.

49. The apparatus of claim 27, wherein the secondary sub-transactions are processed by the client device's attached at least one of event listener, event processor, software framework, metadata, or attribute, which persistently record, measure, time-stamp, or analyze the sub-transactions' content, behaviors, events, performance data, or their associated timing characteristics during the lifetimes of the secondary sub-transactions of the client device; and wherein, the response_time_{—}2nd_nav of the secondary sub-transactions are shorter than the page load time; and wherein, the reconstructed transaction has no dynamic updates.

50. The apparatus of claim 27, wherein the secondary sub-transactions are processed by the client device's attached at least one of event listener, event processor, software framework, metadata, or attribute, which persistently record, measure, time-stamp, or analyze the sub-transactions' content, behaviors, events, performance data, or their associated timing characteristics during the lifetimes of the secondary sub-transactions of the client device; and wherein, at least one of the response_time_{—}2nd_nav of the secondary sub-transactions are longer than the page load time and sub-transactions continuing beyond the page load completion; and wherein, the reconstructed transaction has dynamic updates, and the updates constitute additional transactions.

51. The apparatus of claim 27, wherein the client device's attached and executing at least one of event listener, event processor, software framework, metadata, or attribute persistently record, measure, time-stamp, or analyze the behaviors, events, performance data, or their associated timing characteristics of the client device, or of the client device's network connections and connectivity with access networks.

52. The apparatus of claim 27, the classifier further optimizes performance of inflight transactions between the client device and the host through actions based on the inflight transactions' data and historical trends of the reconstructed transactions and their detected and processed primary and secondary sub-transactions.
